(19) United States
(12) Patent Application Publication
(10) Pub. No.: US 2013/0015238 A1
(43) Pub. Date: Jan. 17, 2013

(54) DETERMINING SHAFT INFORMATION

(71) Applicant: Christian Studer, Luzern (CH)

(72) Inventor: Christian Studer, Luzern (CH)

(21) Appl. No.: 13/545,569

(22) Filed: Jul. 10, 2012

(30) Foreign Application Priority Data
Jul. 13, 2011 (EP) 11173790.4

(51) Int. Cl. B66B 3/02

(52) U.S. Cl. 235/375

(57) ABSTRACT

An information device identifies each individual guide rail on the basis of its code from a learning travel. The information device knows, in the case of a predetermined travel destination, that the first guide rail and the second guide rail are travelled over completely and the third guide rail is travelled over only partly. During the travel merely an identification of the first guide rail and an identification of the second guide rail are read from the code. During travel over of the third guide rail each code pattern is read. The information device is also suitable for measurement of the speed of the elevator cage. In that case each code pattern of the rail run is read and the speed determined therefrom.

### CROSS-REFERENCE TO RELATED APPLICATION

This application claims priority to European Patent Application No. 11173790.4, filed Jul. 13, 2011, which is incorporated herein by reference.

### FIELD

The disclosure relates to shaft information for an elevator installation.

### BACKGROUND

Equipment for generating shaft information in an elevator shaft has become known from U.S. Pat. No. 6,128,116. Strips reflecting infrared light are arranged at specific points at guide rails extending over the shaft height. At least one transceiver, which transmits infrared light to the strips and receives infrared light reflected from the strips, is arranged at an elevator cage movable in the elevator shaft. From the reflected and received light the transceiver generates an electrical signal which images the position of the elevator cage in the elevator shaft. The in situ mounting of the strips in the elevator shaft can be time-consuming. The guide rails may have to be cleaned and the strips may have to be placed precisely by means of a tool.

### SUMMARY

In at least some embodiments, an information device for an elevator installation can be mounted in a relatively short time. The elevator engineer can mount the reader on the elevator cage. The code necessary for the information generation is already arranged at the factory at, for example, guide rails. Other shaft equipment such as, for example, a cable channel, which reaches over the shaft height and which consists of individual cable channel elements, or enlarged door frames are also possible as code carrier. Each guide rail or each cable channel element or each enlarged door frame can be provided over its length with the above-mentioned code at the factory, wherein the coding of each guide rail, each cable channel element or each door frame is of comparable construction. For example, the code images the length, for example 0 meters to 5.00 meters, of the guide rail or the cable channel element or the door frame, wherein in addition each guide rail or each cable channel element or each door frame is provided with an individual identification. The associated reader and control can recognize the sequence of the mounted guide rails or cable channel elements or door frames by way of the identification. The guide rails or the cable channel elements or the door frames can be mounted in any sequence and in any orientation. When the information device is placed in operation the sequence and orientation is detected by a learning travel and stored. During operation the elevator cage travels up and down, wherein the completely transited guide rails are detected by means of the respective identification and the position of the elevator cage and/or the counterweight within the incompletely transited guide rail is determined by means of the code. The absolute cage position is then calculated from the length of the completely transited guide rails and from the transited length of the incompletely transited guide rail.

The speed of the elevator cage can be of significance as, for example, an additional signal for speed regulation in the case of acceleration, constant travel and deceleration. Equally of significance is the speed of the elevator cage for the initiation of measures in the case of excess speed of the elevator cage. In the case of excess speed, for example, the motor is switched off and the motor brake triggered. If these measures do not lead to a reduction in speed, a rail brake, for example, is triggered. The above-mentioned information device can also be used for measuring the speed of the elevator cage. In that case each cage position is determined from the code and the speed is calculated from the path covered and the travel time needed for that purpose.

The same procedure can also be applicable to the cable channel elements and the door frames.

### BRIEF DESCRIPTION OF THE DRAWINGS

The present disclosure is explained in more detail by way of the accompanying figures, in which:

FIG. 1 shows elevator equipment with an information device,

FIG. 2 shows a code with two-dimensional code patterns,

FIG. 3 shows a code with one-dimensional code patterns and

FIG. 4 shows an example for determination of the position of an elevator cage in an elevator shaft.

### DETAILED DESCRIPTION

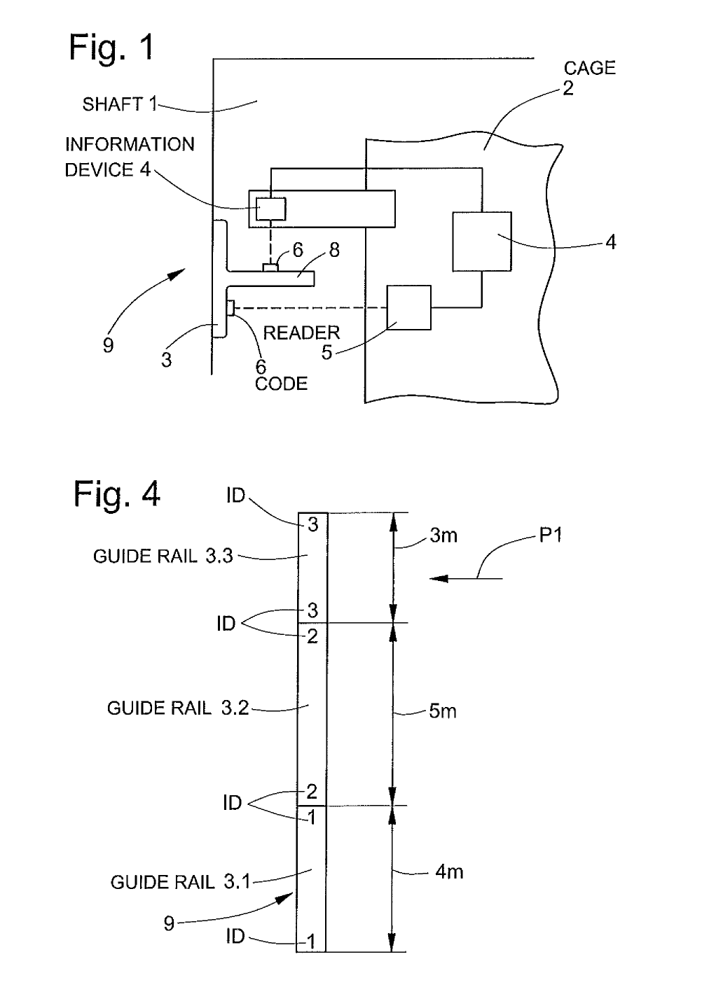

FIG. 1 shows, schematically, a plan view of an elevator cage 2 movable in an elevator shaft 1 and an information device 4. The elevator cage 2 is guided along guide rails forming a rail run 3, wherein only one rail run 3 is shown in FIG. 1. A further rail run is arranged on the opposite side. An information device 4 generates shaft information for control of the cage movement and the cage position or the counterweight movement and counterweight position. The shaft information comprises, for example, the speed and/or position in the elevator shaft of the elevator cage 2 and/or a counterweight. The information device 4 consists, in the illustrated embodiment, of at least one reader 5 and at least one code 6 arranged at shaft equipment 9. In the illustrated embodiment a redundant information device 4 is provided, wherein a code 6 is arranged at the rail run 3, for example at the rail foot 7 of a guide rail, and a further code 6 is arranged at a free limb 8 of the guide rail, and a reader 5 is associated with each code 6. The information device does not have to be of redundant form. In the further variant of embodiment only one code 6 and only one reader 5 are provided. The code 6 can also, as mentioned further above, be arranged at different shaft equipment 9 such as, for example, at a cable channel, which extends over the shaft height and which consists of individual cable channel elements, or, as mentioned further above, at, for example, enlarged door frames.

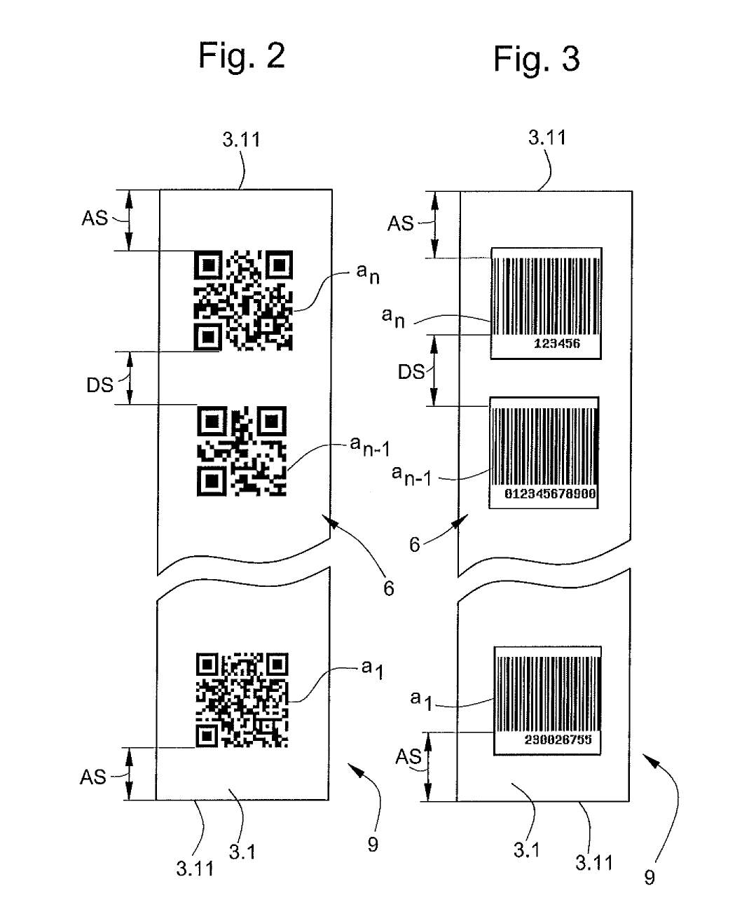

FIG. 2 schematically shows a code 6, which is arranged at shaft equipment 9, with two-dimensional code patterns 2D. Each code pattern consists of a checkered arrangement of fields, wherein each field is black or white depending on the respective information content of the code pattern. The checkered arrangement of the fields is comparable with a checkered sheet of paper in which each square can have a black filling or can be empty. The reader 5 can recognize the image from black and white fields and determine the information content therefrom. A first code pattern at the shaft equipment 9 is denoted by a₁, for example the lowermost code pattern of a guide rail 3.1, a second-to-last code pattern is denoted by aₙ₋₁, for example a second-to-uppermost code pattern of the guide rail 3.1 and a last code pattern is denoted by aₙ, for example an uppermost code pattern of the guide rail 3.1.

The code patterns a₁ to aₙ are different because each code pattern has a different information content. In the lowermost code pattern a₁ and in the uppermost code pattern aₙ of the guide rail 3.1, for example, the position of the code pattern and/or information for triggering an emergency stop and/or the spacing AS of the code pattern from the end of the guide rail 3.1 and/or information ID for identification of the guide rail 3.1 and/or information with respect to the length of the guide rail 3.1 is or are included. The code patterns between the lowermost code pattern a₁ and the uppermost code pattern aₙ are arranged at the guide rail 3.1 at a specific spacing DS from the adjacent code pattern and include at least one item of information with respect to the respective position of the code pattern a₁ . . . aₙ within the guide rail 3.1 or include a readable scale, which extends over the length thereof, in code form.

The information with respect to the position of the code pattern can also be present twice in each code pattern a₁ . . . aₙ, once for travel of the elevator cage 2 in upward direction and once for travel of the elevator cage 2 in downward direction. The guide rails 3.1 can thus be mounted with the first code pattern a₁ at the bottom or at the top.

At least the information ID for identification of the guide rail 3.1 can optionally be present in all code patterns a₁ . . . aₙ. On fresh starting up of the elevator or of the information device 4 the information device 4 can immediately read or determine the information ID for identification of the guide rail 3.1 and the relative position. The information ID for identification of the guide rail 3.1 and the information for determination of the relative position within a guide rail or other information can also be stored in a code. The reader 5 reads the code and the information device 4 individually further processes the different information.

The total length of the guide rail 3.1 even without a code pattern at the rail end 3.11 can be determined by the spacing AS of the code pattern from the end of the guide rail 3.1. If the guide rail 3.1 stretches, the spacing DS between the adjacent code patterns a₁ . . . aₙ changes or increases. Longitudinal errors due to stretching of the guide rail 3.1 are minimal and as a rule do not have to be corrected. However, from time to time a further learning travel by means of which the determined shaft positions can be allocated to the door positions can be performed.

FIG. 3 shows an embodiment of a code 6 with one-dimensional code patterns 1D. Each code pattern consists of a readable barcode. The embodiments with respect to the code patterns of FIG. 2 are equally applicable to the code patterns of FIG. 3.

The embodiments with respect to FIGS. 2 and 3 apply generally to items of shaft equipment 9 such as, for example, guide rails, cable channel elements or enlarged door frames, wherein a guide rail is a shaft equipment element, a cable channel element is a shaft equipment element and an enlarged door frame is a shaft equipment element. Oil-free guide rails travelled over by roller guide shoes are particularly suitable as shaft equipment elements. Each guide rail, each cable channel element or each enlarged door frame is provided over its length with the above-mentioned code at the factory, wherein each guide rail has in the code its own identification and its own readable scale extending over the length thereof, each cable channel element has in the code its own identification and its own readable scale extending over the length thereof or each door frame has in its code its own identification and its own readable scale extending over the length thereof.

The code 6 can, for example, be arranged as a strip at the shaft equipment 9 or impressed, punched, lasered or spiked into the shaft equipment 9.

FIG. 4 shows an example for determination of the position of the elevator cage 2 and/or the counterweight in the elevator shaft 1. Guide rails 3.1 . . . 3.3 serve as carrier for the code 6. A first guide rail 3.1 is characterized by the identification ID=1 and has a length of 4 meters, a second guide rail 3.2 is characterized by the identification ID=2 and has a length of 5 meters and a third guide rail 3.3 is characterized by the identification ID=3 and has a length of 3 meters. In FIG. 4 the first guide rail 3.1 is connected with the second guide rail 3.2 and the second guide rail is connected with the third guide rail 3.3. No codes 6 are needed at the connecting points. The distance between the last code of one guide rail and the first code of another guide rail is known through the spacing AS.

After mounting of the guide rails 3.1 . . . 3.3 coded at the factory the elevator cage 2 performs a learning travel in the elevator shaft 1. In that case the information device 4 stores the information readable from the code 6 by means of the at least one reader 5. The stored information is an image of the information present in each code pattern. If, for example, a code pattern during transit cannot be read by the reader 5 due to damage or dirtying, the missing information is replaced by the stored information and, for example, an error report or maintenance report is logged.

In the example shown in FIG. 4, the elevator cage 2 travels upwardly with or without passengers from the lowermost story. The information device 4 recognizes the travel destination and the travel direction. From a learning travel the information device 4 also recognizes the individual guide rails 3.1 . . . 3.3 on the basis of the code 6 thereof and thus also the complete rail run 3 consisting of the guide rails 3.1 . . . 3.3. The information device 4 knows, in the case of the predetermined travel destination, that the first guide rail 3.1 and the second guide rail 3.2 are travelled over completely and the third guide rail 3.3 is travelled over only partly. During the journey merely the identification of the first guide rail 3.1 and the identification of the second guide rail 3.2 are read. Each code pattern a₁ . . . aₙ is read during travel over the third guide rail 3.3. On the first 9 meters of the passenger journey only the identifications ID of the first two guide rails are read, on the last 0.8 meters up to the destination—which is denoted by an arrow P1—of the passenger journey all code patterns a₁ . . . aₙ of the third guide rail 3.3 are read and on reaching the destination P1 the elevator cage 2 or the counterweight is completely stopped.

The above-mentioned information device 4 can also be used for measuring the speed of the elevator cage 2. In that case the cage position is determined at each code pattern a₁ . . . aₙ of the rail run 3 and the speed is calculated from the path covered and the travel time required for that purpose.

Having illustrated and described the principles of the disclosed technologies, it will be apparent to those skilled in the art that the disclosed embodiments can be modified in arrangement and detail without departing from such principles. In view of the many possible embodiments to which the principles of the disclosed technologies can be applied, it should be recognized that the illustrated embodiments are only examples of the technologies and should not be taken as limiting the scope of the invention. Rather, the scope of the invention is defined by the following claims and their equivalents. I therefore claim as my invention all that comes within the scope and spirit of these claims.

I claim:

1. An elevator device comprising:
shaft equipment, the shaft equipment comprising a plurality of individual elements;
a code, the code comprising a plurality of code patterns, the plurality of code patterns being distributed among the plurality of individual elements of the shaft equipment, each of the code patterns comprising an individual identification and an individual scale; and
a reader for reading the code and generating shaft information.

2. The elevator device of claim 1, each of the code patterns comprising a respective one-dimensional pattern.

3. The elevator device of claim 1, each of the code patterns comprising a respective two-dimensional pattern.

4. The elevator device of claim 1, the individual elements of the shaft equipment comprising guide rails.

5. The elevator device of claim 1, the individual elements of the shaft equipment comprising cable channel elements.

6. The elevator device of claim 1, the individual elements of the shaft equipment comprising door frames.

7. An elevator method, comprising:
completely traveling over a first portion of shaft equipment with an elevator cage or with a counterweight;
reading an identification from a first code on the first portion of shaft equipment using a reader;
partially travelling over a second portion of shaft equipment with the elevator cage or with the counterweight; and
reading a length of a scale from a second code on the second portion of the shaft equipment using the reader.

8. The elevator method of claim 7, further comprising generating shaft information based on the identification from the first code and the length of the scale from the second code.

9. The elevator method of claim 7, the identification from the first code and the length of the scale from the second code being read during a learning travel.

10. The elevator method of claim 7, further comprising determining a length of transited shaft equipment based on the identification from the first code and the length of the scale from the second code.

11. The elevator method of claim 7, further comprising determining an elevator cage speed based on the identification from the first code and the length of the scale from the second code.

12. The elevator method of claim 7, the completely traveling over the first portion of the shaft equipment and the partially traveling over the second portion of the shaft equipment being performed with the elevator cage.

13. The elevator method of claim 7, the completely traveling over the first portion of the shaft equipment and the partially traveling over the second portion of the shaft equipment being performed with the counterweight.
